(19) United States
(12) Patent Application Publication
(10) Pub. No.: US 2009/0165540 A1
(43) Pub. Date: Jul. 2, 2009

(54) METHOD FOR MEASURING BLADE TIP CLEARANCE

(76) Inventor: Terry A. Craig, Greenup, KY (US)

Correspondence Address: GENERAL ELECTRIC COMPANY, GE AVIATION, ONE NEUMANN WAY MD H17, CINCINNATI, OH, 45215, US

(21) Appl. No.: 11/967,197

(22) Filed: Dec. 29, 2007

(51) Int. Cl. G01M 15/14

(52) U.S. Cl. 73/112.01

(57) ABSTRACT

A method for measuring blade tip clearance for a gas turbine engine having a fan case assembly and a rotor having a plurality of blades may include the steps of removably attaching a measurement tool to the fan case assembly, the measurement tool having a sensor, rotating the rotor, and measuring blade tip clearance for the plurality of blades during the rotation of the rotor.

### BACKGROUND OF THE INVENTION

The exemplary embodiments relate generally to gas turbine engines and more specifically to apparatus for measuring the clearance of blade tips.

Gas turbine engines, steam turbines, aircraft engines, jet engines and other axial flow turbomachinery are typically designed to minimize the radial gaps between the blade tips and the blade housings or cases. Gaps between the blade tips and the cases can reduce efficiency by allowing gas or air to leak into the downstream stages of engine operation. The gaps between the blade tips and the cases are a function of engine speed and temperature, and the gaps changes during engine operation. High operating rotational speeds can cause radial elastic growth in rotating hardware (i.e. blades), resulting in radial blade tip growth. Additionally, high temperatures cause thermal expansion in the case and in the rotating hardware. Currently several inspection methods for determining the gap between the blade tips and the fan cases at operating speed are being used.

One method for determining the gap between the blade tips and the case utilizes a thin metal rod inserted and fastened into an axially drilled bolt, the resulting assembly being inserted into a mount plate attached to the fan case. The end of the rod is located where the blade tips should be. The method requires that the engine be operated for a specified time period after which the amount of wear on the rod is measured to determine the change in the gap between the blade tips and the case. The method is insufficient in that the thin metal rods often bend or break which renders measurement thereof moot. In addition, metal liberated from the thin metal rod, either as pieces or as powder can cause damage to the engine. Further, making these thin metal rods can be both difficult and time consuming because each rod must be custom made using a measurement of distance from the fan case to the blade tip. Further, such a method suffers from errors such as measurement, data recording, and machining. It is often the case that the thin metal rods are made either too short or too long. Short rods do not rub the blade tip, while long rods bend or break. Further still, this assembly requires addition of holes in the fan case, which may weaken the case and possible cause structural damage after an extended period of use.

Another method utilizes a taper gage and gage block to determine the tip clearance for each individual blade. The gage block is placed on the interior of the fan case and the taper gage is placed on top of the block. The taper gage slides along the gage block until it contacts the blade. The technician may then read the taper gage to determine the gap between the blade and the case. This process is repeated for each blade. This is very time consuming and leads to longer manufacturing and overhaul times. This technique may also be prone to errors. These errors may include, bridging of the fan case by the gage block, measurement reading errors and parallax error when reading the taper gage. Furthermore, with the rake angle that may be applied to the blade tip, it may not be possible to read the gage at the point of contact.

### BRIEF DESCRIPTION OF THE INVENTION

In one exemplary embodiment, a method for measuring blade tip clearance for a gas turbine engine having a fan case assembly and a rotor having a plurality of blades may include the steps of removably attaching a measurement tool to the fan case assembly, the measurement tool having a sensor, rotating the rotor, and measuring blade tip clearance for the plurality of blades during the rotation of the rotor.

### BRIEF DESCRIPTION OF THE DRAWINGS

FIG. 1 is a cross-sectional schematic view of an exemplary gas turbine engine.

FIG. 2 is a cross-sectional view of an exemplary fan assembly.

FIG. 3 is a perspective view of an exemplary embodiment of a measurement tool.

FIG. 4 is a cross-sectional view of an exemplary fan assembly shown having an exemplary embodiment of a measurement tool installed thereupon.

FIG. 5 is a close-up cross-sectional view of the area 5 circled in FIG. 4.

FIG. 6 is a top view of an exemplary fan assembly taken along line 6-6 in FIG. 4, shown having an exemplary embodiment of a measurement tool installed thereupon.

FIG. 7 is a bottom view of an exemplary fan assembly shown having an exemplary embodiment of a measurement tool installed thereupon.

FIG. 8 is a perspective view of an exemplary embodiment of a bushing shown an installed condition.

### DETAILED DESCRIPTION OF THE INVENTION

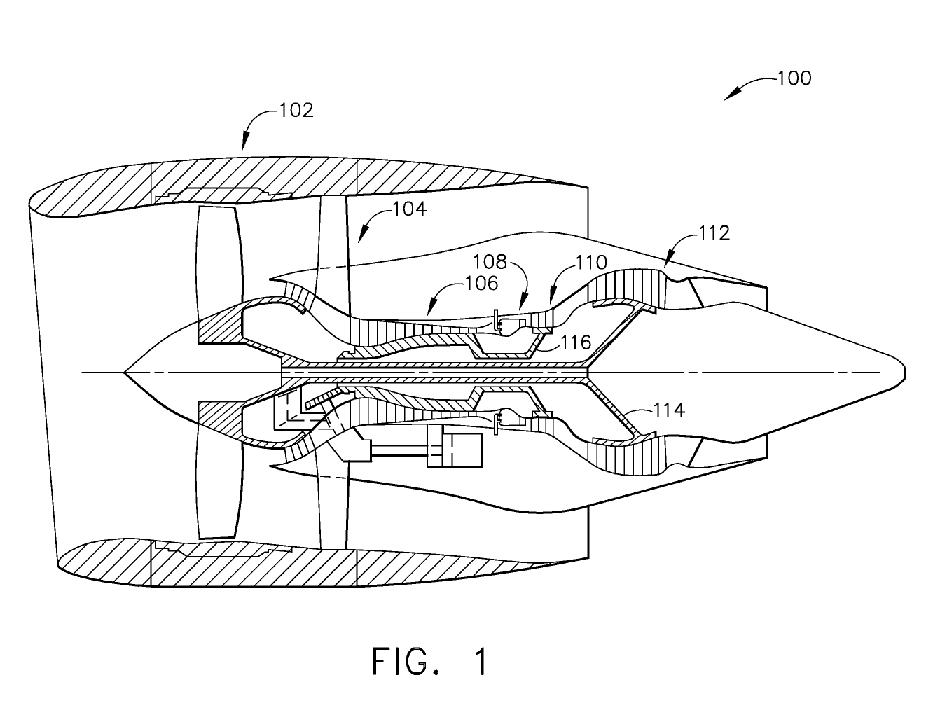

FIG. 1 illustrates a cross-sectional schematic view of an exemplary gas turbine engine 100. The gas turbine engine 100 may include a fan assembly 102, low-pressure compressor 104, a high-pressure compressor 106, a combustor 108, a high-pressure turbine 110, and a low-pressure turbine 112. The fan assembly 102 and low-pressure compressor 104 may be coupled to the low-pressure turbine 112 through a shaft 114. The high-pressure compressor 106 may be coupled to the high-pressure turbine 110 through a shaft 116. In operation, air flows through the fan assembly 102, low-pressure compressor 104 and high-pressure compressor 106. The highly compressed air is delivered to the combustor 108, where it is mixed with a fuel and ignited to generate combustion gases. The combustion gases are channeled from the combustor 108 to drive the turbines 110 and 112. The turbine 112 drives the fan assembly 102 and low-pressure compressor 104 by way of shaft 114. The turbine 110 drives the high-pressure compressor 106 by way of shaft 116.

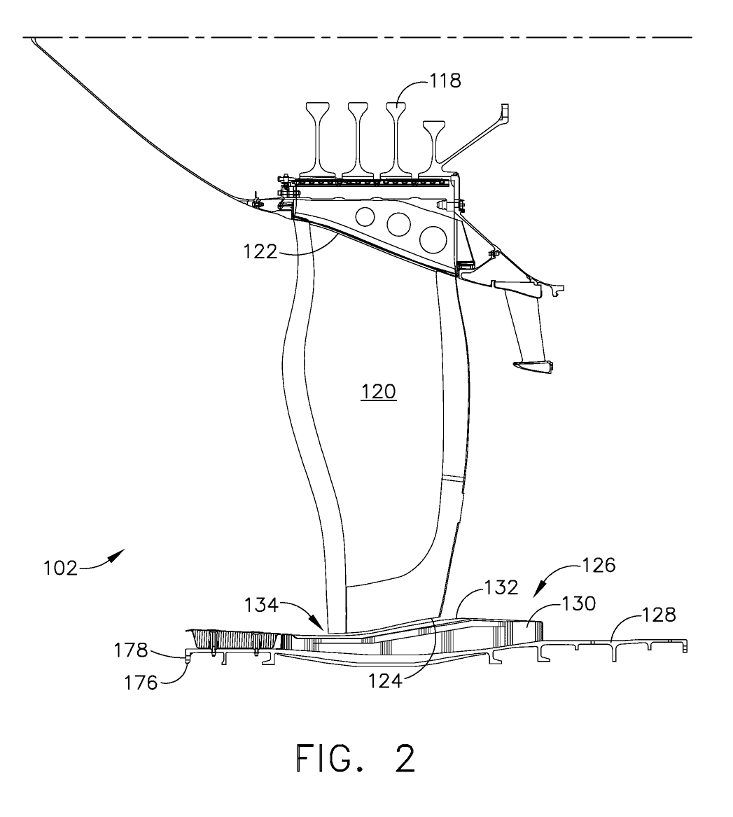

FIG. 2 illustrates a cross-sectional view of an exemplary fan assembly 102. FIG. 2 shows the bottom portion of the fan assembly. Tip clearance is typically measured at the bottom center of the fan case. It should be noted that the measurement can occur at any position around the circumference of the fan casing and the exemplary embodiments should not be limited to just the bottom portion. The fan assembly 102 may include a rotor 118, which may receive a plurality of fan blades 120. Alternatively, the rotor 118 may be a blisk where a plurality of airfoils integral with the rotor 118 extend outwardly therefrom. The fan blades 120 extend radially from a platform 122 to a tip 124. A fan case assembly 126 radially bounds the tip 124. The fan case assembly 126 may include a fan case 128 and a fan shroud 130. The fan shroud 130 has a radially inner surface 132. Together, the blade tip 124 and inner surface 132 of the fan shroud 130 define a gap 134.

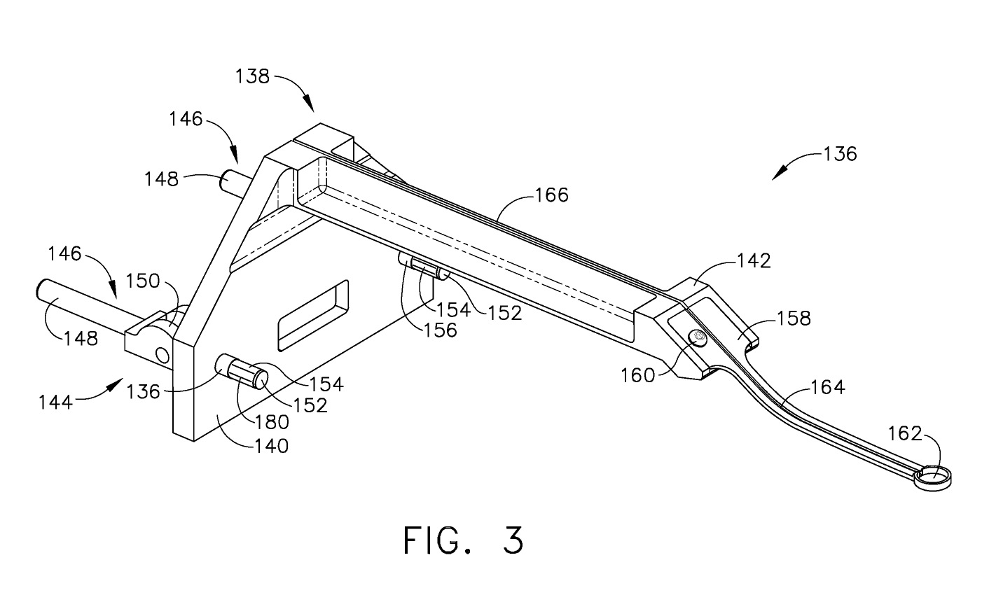

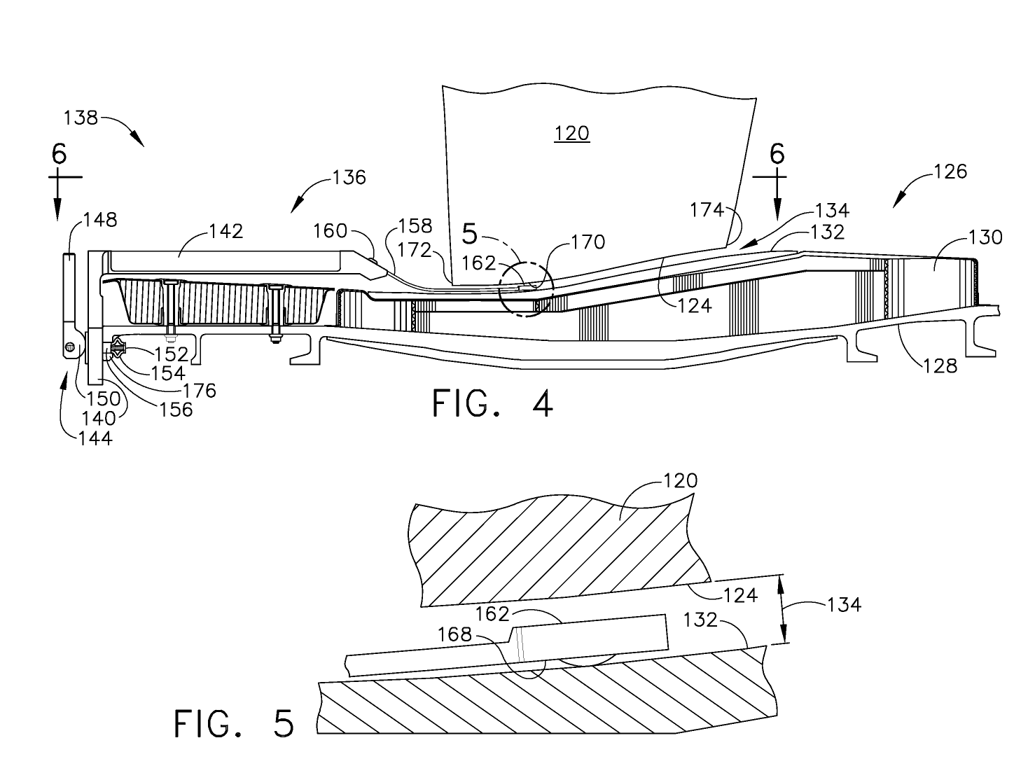

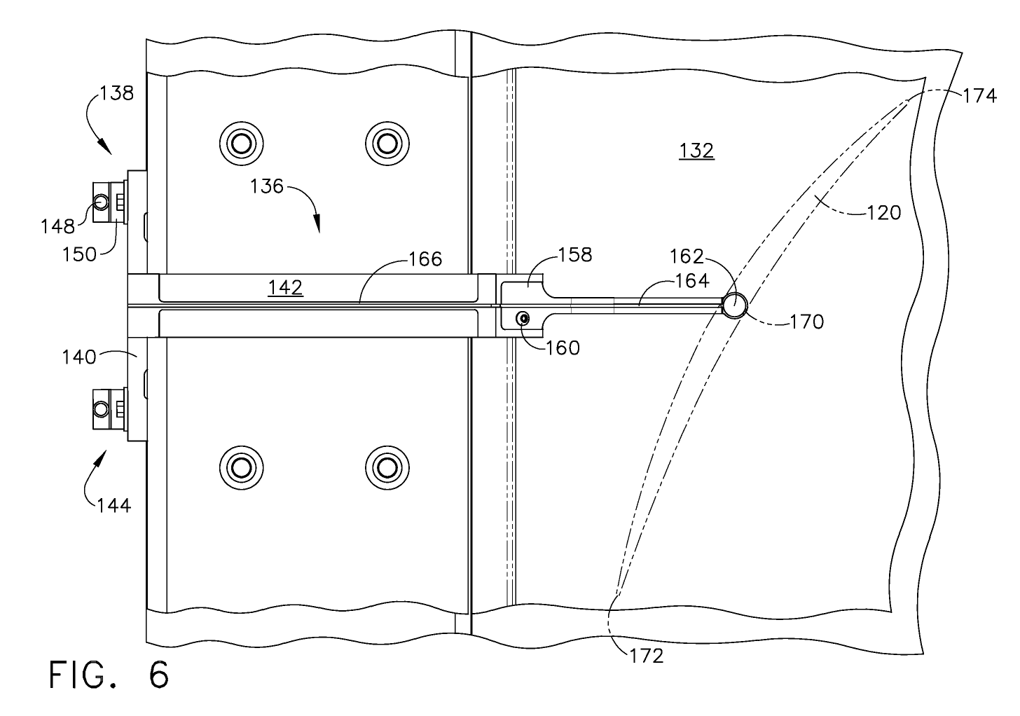

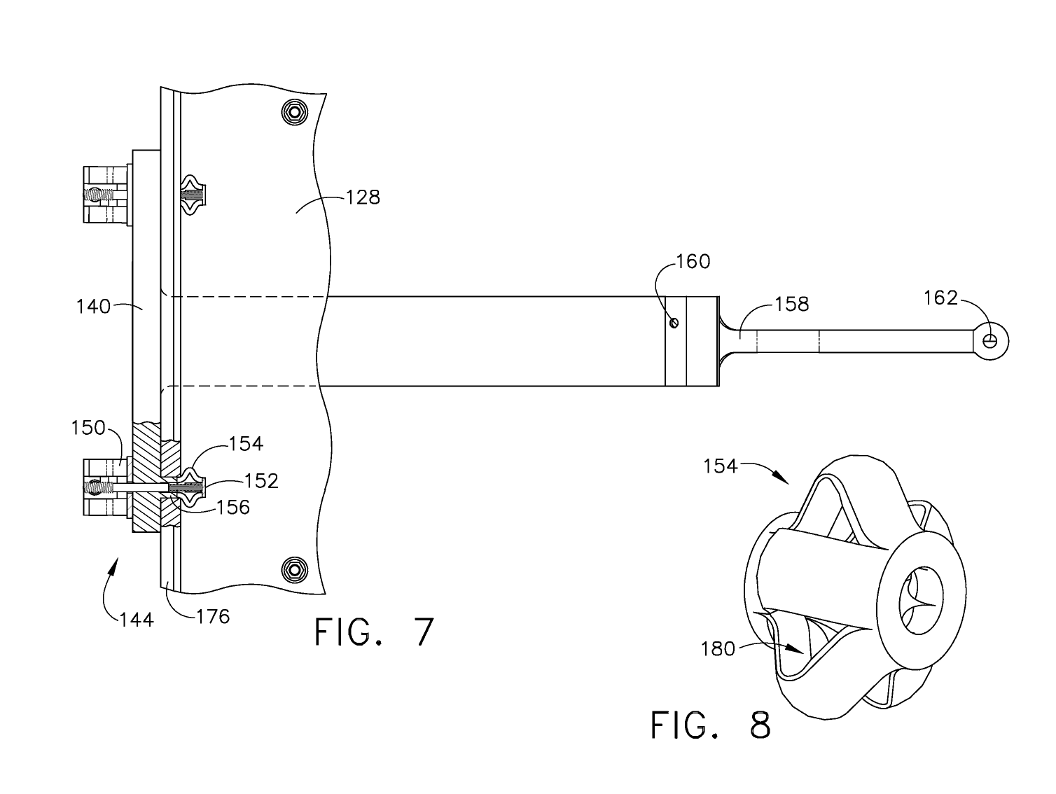

FIGS. 3-7 illustrate an exemplary embodiment of a measurement tool 136 for measuring the height of the gap 134 or the distance between the blade tip 124 and the inner surface 132 of the fan shroud 130 at various points along the axial length of the blade tip 124. The measurement tool 136 has a frame 138. The frame 138 may include a backing portion 140 and an extended portion 142. It should be noted that any configuration of the frame 138 might be used so long as the measurement tool 136 may be attached securely to the fan case assembly 126. The backing portion 140 may include an attachment system 144. Any attachment system known in the art may be used so long as the measurement tool 136 may be attached securely to the fan case assembly 126. In one exemplary embodiment, the attachment system may include a plurality of clamps 146. The clamps 146 may be any clamping mechanism known in the art, such as but not limited to, a cam clamp, over center clamp, vice clamp, or any other similar clamp. The clamps 146 may include a lever 148 and a cam 150, which may cooperate with a screw 152 and a bushing 154 to securely attach the measurement tool 136 to the fan case assembly 126. The clamps 146 may have a locked and unlocked position. The unlocked position is shown in FIG. 3. The locked position is shown in FIG. 4 and will be described in more detail below. The clamps 146 may be spaced apart such that the screw 152, bushing 154 and post 156 may be placed into existing holes in the fan case assembly 126. This allows the measurement to occur without modification to the fan case assembly 126.

An arm 158 may be attached to the frame 128. In one exemplary embodiment, the arm 158 may be attached to the extended portion 142 with a screw 160 or any other attachment mechanism. In another exemplary embodiment, the arm 158 may be attached using a hinge and spring mechanism that may bias the arm 158 into contact with the fan case 128. Any attachment mechanism known in the art may be used. The arm 158 may be attached at one end and free at the other. The free end may include a sensor 162. The sensor 162 may be any sensor known in the art that can measure the distance between two points. In one exemplary embodiment, the sensor 162 may be a non-contact displacement sensor, such as, but not limited to, a capacitive position sensor or an optical sensor. The sensor 162 may have a lead 164 that may pass from the sensor 162 along a channel 166 to electronic components located remotely from the measurement tool 136. As shown in FIG. 5, the arm 158 may have a protrusion 168 for contacting the surface 132 and stabilizing the sensor 162. In one exemplary embodiment, the protrusion 168 may be spherical. Any number of arms 158 may be used and any number of sensors 162 may be used on each arm 158. The arm 158 may be any length or width so long as when the measurement tool 136 is attached to the fan case assembly 126, the sensor or sensor 162 are placed in appropriate measurement locations such as, but not limited to, the center of the blade 170, the leading edge 172, and/or the trailing edge 174. The arm 158 may be attached such that it is easily removed or replaced, for example, should a blade 120 contact the arm 158 during measurement and break or to take measurements in different locations by changing to a different arm.

The measurement tool 136 may be installed onto the fan case assembly 126 through fan case forward flange 176. The forward flange 176 may have a plurality of holes 178 for receiving screws 152, bushings 154 and posts 156. The lever 148 may then be actuated into the locked position. The screw 152 may be pulled towards the forward flange and cause the bushing 154 to expand along slots 180, as shown in FIG. 8. The bushing 154 may apply axial force to the forward flange 176 and pull the measurement tool 136 against the forward flange 176 to substantially eliminate any gaps therebetween. The location and configuration of the measurement tool 136 may be predetermined so as to align the sensor 162 with the area of the blades 120 to measure. Once the measurement tool 136 is locked into position, the sensor 162 may begin to take measurements as the fan blades 120 are rotated. The sensor 162 can obtain data for each of the fan blades 120 in a single rotation; however, it should be understood that data may be obtained for more than one rotation. The measurement tool 136 may be attached and take measurements in a relatively short period of time, while ensuring accurate measurements. Furthermore, the tool does not require any additional holes or structural transformation of the fan case assembly since it uses established holes for assembly. This leads to a reduced production cycle and produces accurate and reliable tip clearance measurements.

This written description discloses exemplary embodiments, including the best mode, to enable any person skilled in the art to make and use the exemplary embodiments. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for measuring blade tip clearance for a gas turbine engine having a fan case assembly and a rotor having a plurality of blades, comprising:
removably attaching a measurement tool to said fan case assembly, said measurement tool having a sensor;
rotating said rotor; and
measuring blade tip clearance for said plurality of blades during said rotation of said rotor.

2. The method of claim 1 wherein said attaching step further comprises:
placing a screw and bushing associated with said measurement tool, through a hole in said fan case assembly.

3. The method of claim 2 wherein said attaching step further comprises:
locking a clamp associated with said measurement tool causing said screw and bushing to secure said measurement tool to said fan case assembly.

4. The method of claim 3 wherein said locking step further comprises:
expanding said bushing to cause axial force to be applied to said fan case assembly.

5. The method of claim 4 further comprising:
aligning said sensor with a portion of said blades to be measured.

6. The method of claim 1 wherein said attaching step further comprises:
locking a clamp associated with said measurement tool causing said measurement tool to be secured to said fan case assembly.

7. The method of claim 1 further comprising:
aligning said sensor with a portion of said blades to be measured.
